(19) United States
(12) Patent Application Publication
(10) Pub. No.: US 2026/0018166 A1
(43) Pub. Date: Jan. 15, 2026

(54) TEXT PROCESSING METHOD AND APPARATUS, ELECTRONIC DEVICE, AND STORAGE MEDIUM

(71) Applicant: Tencent Technology ( Shenzhen ) Company Limited, Shenzhen (CN)

(72) Inventors: Dongling XIAO, Shenzhen (CN); Jiaqi Han, Shenzhen (CN); Gang Yuan, Shenzhen (CN); Binghuai Lin, Shenzhen (CN)

(21) Appl. No.: 19/334,646

(22) Filed: Sep. 19, 2025

Related U.S. Application Data
(63) Continuation of application No. PCT/CN2024/105480, filed on Jul. 15, 2024.

(30) Foreign Application Priority Data
Sep. 18, 2023 (CN) 202311201003.7

(51) Int. Cl. G10L 15/14; G10L 15/06; G10L 15/22; G10L 15/26

(52) U.S. Cl. CPC G10L 15/14; G10L 15/063; G10L 15/22; G10L 15/26; G10L 2015/0631

(57) ABSTRACT

A text processing method performed by an electronic device includes: obtaining a text of a spoken language request; predicting a quantity N of sub-requests of the spoken language request and N sub-request texts in one-to-one correspondence with the N sub-requests through a prediction model by using the spoken language request text, N being a positive integer; and predicting target instruction information corresponding to each of the N sub-request texts through the prediction model based on the quantity N of sub-requests and the N sub-request texts for determining a response to the spoken language request.

### CROSS-REFERENCE TO RELATED APPLICATIONS

This application is a continuation application of PCT Patent Application No. PCT/CN2024/105480, entitled “TEXT PROCESSING METHOD AND APPARATUS, ELECTRONIC DEVICE, AND STORAGE MEDIUM” filed on Jul. 15, 2024, which claims priority to Chinese Patent Application No. 2023112010037, entitled “TEXT PROCESSING METHOD AND APPARATUS, ELECTRONIC DEVICE, AND STORAGE MEDIUM” filed on Sep. 18, 2023, both of which are incorporated herein by reference in their entirety.

### FIELD OF THE TECHNOLOGY

This application relates to the technical field of artificial intelligence, and specifically, to a text processing method and apparatus, an electronic device, and a storage medium.

### BACKGROUND OF THE DISCLOSURE

In recent years, with the rapid development of artificial intelligence technology, intelligent voice assistant products based on artificial intelligence technology have been widely applied in people's daily lives. Through intelligent voice assistant products, users can control intelligent devices by using only voice. Spoken language understanding is a core algorithmic capability of the intelligent voice assistant products.

In practical application, when utilizing spoken language understanding to parse user queries, the intelligent voice assistant products often face a plurality of spoken language understanding scenarios, such as multi-intent spoken language understanding scenarios and single-intent spoken language understanding scenarios. The multi-intent spoken language understanding scenarios refer to identifying a plurality of intents from a spoken sentence, while the single-intent spoken language understanding scenarios refer to identifying a single intent from a spoken sentence.

However, in the related art, systems of the intelligent voice assistant products are typically configured with a plurality of separate models to support the plurality of spoken language understanding scenarios, for example, each of the plurality of models may specifically process texts generated in one spoken language understanding scenario, resulting in complex system models of the intelligent voice assistant products and high training and continuous iteration costs of the models in the systems.

### SUMMARY

Embodiments of this application provide a text processing method and apparatus, an electronic device, and a storage medium.

In one aspect, a text processing method is provided, performed by an electronic device, and including:
obtaining a text of a spoken language request;
predicting a quantity N of sub-requests of the spoken language request and N sub-request texts in one-to-one correspondence with the N sub-requests through an application of a prediction model to the spoken language request text, N being a positive integer; and
predicting target instruction information corresponding to each of the N sub-request texts through the prediction model based on the quantity N of sub-requests and the N sub-request texts for determining a response to the spoken language request.

In another aspect, an embodiment of this application further provides an electronic device, including a memory storing a plurality of instructions; and a processor loading the instructions from the memory to cause the electronic device to perform the operations in any text processing method provided by the embodiments of this application.

In yet another aspect, an embodiment of this application further provides a non-transitory computer-readable storage medium, the computer-readable storage medium having a plurality of instructions stored therein, the instructions, when loaded by a processor of a computer device, causing the computer device to perform the operations in any text processing method provided by the embodiments of this application.

Details of one or more embodiments of this application are proposed in the accompanying drawings and descriptions below. Other characteristics, objectives, and advantages of this application will become apparent from the description, the drawings, and claims.

### BRIEF DESCRIPTION OF THE DRAWINGS

To more clearly illustrate the technical solutions in the embodiments of this application or conventional technologies, the accompanying drawings required in the description of the embodiments or conventional technologies will be briefly introduced below. Apparently, the accompanying drawings described below are merely embodiments of this application. For a person of ordinary skill in the art, other drawings can also be derived from the disclosed drawings without any creative efforts.

FIG. 1 is a schematic flowchart of multi-scenario spoken language understanding in the related art according to an embodiment of this application.

FIG. 2 is a schematic diagram of an application scenario of a text processing method according to an embodiment of this application.

FIG. 3 is a schematic flowchart of a text processing method according to an embodiment of this application.

FIG. 4 is a schematic flowchart of constructing a training dataset according to an embodiment of this application.

FIG. 5 is a schematic flowchart of updating a sample text according to an embodiment of this application.

FIG. 6 is a schematic flowchart of another text processing method according to an embodiment of this application.

FIG. 7 is a schematic flowchart of merging sample texts in a multi-round spoken language understanding scenario according to an embodiment of this application.

FIG. 8 is a schematic flowchart of concatenating sample texts in a single-intent scenario according to an embodiment of this application.

FIG. 9 is a schematic diagram of input and output of a generative large language model according to an embodiment of this application.

FIG. 10 is a schematic diagram of a loss function for negative sample training according to an embodiment of this application.

FIG. 11 is a schematic diagram of a training process and an inference process of a prediction model according to an embodiment of this application.

FIG. 12 is a schematic structural diagram of a text processing apparatus according to an embodiment of this application.

FIG. 13 is a schematic structural diagram of an electronic device according to an embodiment of this application.

### DESCRIPTION OF EMBODIMENTS

The technical solutions in the embodiments of this application will be clearly and completely described below with reference to the accompanying drawings therein. Apparently, the described embodiments are merely some of the embodiments of this application, not all of them. Based on the embodiments of this application, all other embodiments obtained by those of ordinary skill in the art without any creative efforts fall within the scope of protection of this application.

As a core algorithmic capability of intelligent voice assistant products, spoken language understanding plays a crucial role in many fields such as smart homes, smart speakers, and smart vehicle controls, and is an important link in improving user experience. Therefore, spoken language understanding technology is now widely applied in various smart devices with voice assistants.

However, in practical application, spoken language understanding also faces many challenges, such as huge tagging systems, complex and variable user expressions, multi-round user's continuous requests, and negative user instructions. To address these challenges, the related art primarily configures a plurality of subsystems that operate independently. The configuration of a plurality of models leads to relatively high training and iteration costs. In addition, the system migration capability is relatively weak, for example, when languages (such as foreign languages or dialects) are switched, the plurality of models need to be re-trained and re-deployed.

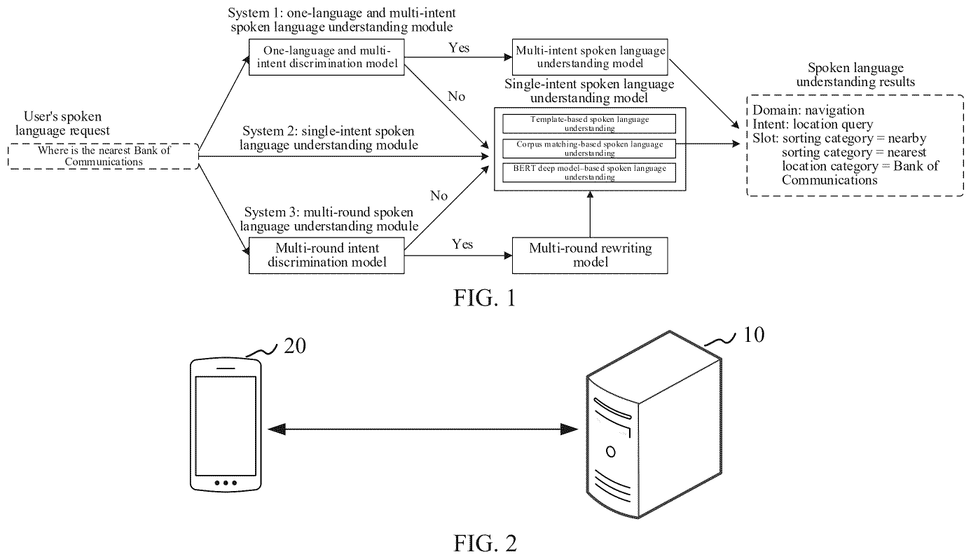

As an example, as shown in FIG. 1, a multi-subsystem mode is employed in the related art to solve user's spoken language requests (hereinafter referred to as spoken language requests) in single-intent spoken language understanding (SLU) scenarios, one-language and multi-intent spoken language understanding scenarios, and multi-round spoken language understanding scenarios. An overall spoken language understanding system may include a plurality of subsystems, i.e., system 1: one-language and multi-intent spoken language understanding module; system 2: single-intent spoken language understanding module; and system 3: multi-round spoken language understanding module.

The system 1 includes a one-language and multi-intent discrimination model and a multi-intent spoken language understanding model, the one-language and multi-intent discrimination model is configured to discriminate whether a received user's spoken language request has a plurality of intents, and the multi-intent spoken language understanding model is configured to output a corresponding spoken language understanding result based on the multi-intent user's spoken language request. The single-intent spoken language understanding model may implement 3 single-intent spoken language understanding methods: rule-based template spoken language understanding, corpus matching spoken language understanding, and bidirectional encoder representations from transformers (BERT) deep model-based spoken language understanding recognition. The template spoken language understanding may provide spoken language understanding results corresponding to a user's spoken language request matching template. The corpus matching spoken language understanding may provide spoken language understanding results in a users' spoken language matching corpus.

For example, if the user's spoken language request is: Where is the nearest Bank of Communications. The one-language and multi-intent discrimination model is configured to discriminate whether the user's spoken language request has a plurality of intents. Based on the user's spoken language request, the multi-intent spoken language understanding model may be configured to output corresponding spoken language understanding results, including a domain, an intent, and a slot. The domain is navigation, the intent is location query, the slots include a sorting category and a location category, the sorting category is nearby and/or nearest, and the location category is Bank of Communications.

The system 2 includes a single-intent spoken language understanding model, which is configured to output corresponding spoken language understanding results based on the single-intent user's spoken language request.

The system 3 includes a multi-round intent discrimination model and a multi-round rewriting model. The multi-round intent discrimination model is configured to discriminate whether the received user's spoken language request is a multi-round intent request, such as whether the current round of spoken language request depends on previous rounds of spoken language requests. The multi-round rewriting model is configured to rewrite the multi-intent user's spoken language request into a single-intent user's spoken language request, such as rewrite the current round of spoken language request into a complete text unrelated to rounds of spoken language requests previous to the current round.

It can be seen that the use of a multi-subsystem mode in the related art results in complex system models, high deployment and continuous iteration costs of the system, and poor cross-lingual migration capabilities. Moreover, such a mode has relatively poor spoken language understanding recognition capabilities, particularly in cold start and small sample scenarios. In addition, this mode has weak multi-round spoken language understanding capabilities, and can process only 2 rounds of requests, thereby limiting practical application scenarios.

In view of the above problems, embodiments of this application provide a text processing method and apparatus, an electronic device, and a storage medium.

The text processing apparatus may be specifically integrated into an electronic device, and the electronic device may be a terminal, a server, or the like. The terminal may include, but is not limited to, a mobile phone, a computer, an intelligent voice interaction device, a smart home appliance, a vehicle terminal, an aircraft, or the like. The server may be a single server or a server cluster composed of a plurality of servers.

In some embodiments, the text processing apparatus may alternatively be integrated into a plurality of electronic devices. For example, the text processing apparatus may be integrated into a plurality of servers, and the plurality of servers cooperate to implement the text processing method of this application. In some embodiments, the terminal may alternatively be used as a server to implement some or all of the functions of the server.

As an example, FIG. 2 is a schematic diagram of an application scenario of a text processing method according to an embodiment of this application.

As shown in FIG. 2, the application scenario may include an electronic device 10 and a smart device 20. The text processing method may be applied to the electronic device 10. The electronic device 10 includes, but is not limited to, a mobile phone, a tablet, a smart Bluetooth device, a laptop, a personal computer, a vehicle terminal, a smart wearable device, or the like. The electronic device 10 may be connected to the smart device 20 by communication.

The smart device 20 may be an object that a user currently needs to control through voice. The smart device 20 may include, but is not limited to, a smart speaker, a smart home device, a smart car, or the like. In some embodiments, the smart home device includes, but is not limited to, a smart clothes rack, a smart refrigerator, a smart television, a smart lighting device, or the like. The quantity of the smart device 20 may be one or more, without limitation herein.

The electronic device 10 may obtain a spoken language request text expressing a spoken language request, predict a quantity N of sub-requests and N sub-request texts of the spoken language request through a prediction model (N is a positive integer), and then predict target instruction information corresponding to each of the N sub-request texts through the prediction model based on the quantity N of sub-requests and the N sub-request texts, the target instruction information including an intent, a domain, and a slot, and the target instruction information corresponding to each of the N sub-request texts being configured for determining a response to the spoken language request. In practical applications, upon receiving a user's target speech from the smart device 20, the electronic device 10 may recognize the target speech as a spoken language request text, input the spoken language request text into the prediction model to obtain target instruction information corresponding to the spoken language request text, and then transmit the control instruction corresponding to the target instruction information to the smart device 20, to control the smart device 20 to perform a corresponding operation.

In some implementations, the object that the user currently needs to control through speech may be the electronic device 10. For example, the electronic device 10 is a mobile phone, and the user can ask a question to the mobile phone through the target speech. Upon receiving the target speech, the mobile phone may recognize the target speech as the spoken language request text, and input the spoken language request text into the prediction model to obtain the target instruction information corresponding to the spoken language request text. Afterwards, the mobile phone may query the control instruction corresponding to the target instruction information and answer the user's question based on the control instruction.

The following provides an explanation of some concepts involved in this application.

Artificial intelligence (AI) is a technology that utilizes digital computers to simulate human perception of the environment, obtain knowledge, and use knowledge. This technology enables machines to have functions similar to human perception, inference, and decision-making. Basic technologies of the artificial intelligence generally include sensors, specialized artificial intelligence chips, cloud computing, distributed storage, big data processing, operation/interaction systems, mechatronics, and the like. Artificial intelligence software technologies mainly include computer vision, speech processing, nature language processing, machine learning/deep learning, autonomous driving, intelligent transportation, and the like.

Key technologies of the speech technology include automatic speech recognition, speech synthesis, and voiceprint recognition, enabling computers to listen, see, speak, and feel, and representing the future direction of human-computer interaction, with speech emerging as one of the most promising interaction modalities.

Nature language processing (NLP) is an important direction in the fields of computer science and artificial intelligence. The NLP studies various theories and methods that enable effective communication between humans and computers in nature languages. Nature language processing is a science that integrates linguistics, computer science, and mathematics. Research in this field will involve nature languages, namely, languages people use in their daily lives. Therefore, the NLP is closely related to the research of linguistics. The nature language processing technologies generally include text processing, semantic understanding, machine translation, robot question answering, knowledge graphs, and the like.

With ongoing research and advancements in artificial intelligence (AI) technology, AI is being explored and applied in many fields, such as common smart homes, smart wearables, virtual assistants, smart speakers, smart marketing, unmanned driving, autonomous driving, unmanned aerial vehicles, robots, intelligent health care, intelligent customer service, the Internet of vehicles, and intelligent transportation. It is believed that, as the technology continues to evolve, AI will be applied in more fields and create increasingly significant value.

Spoken language understanding refers to understanding instruction request information in human spoken language, including the domain, intent, and slot of an instruction, and then controlling a machine (such as a smart home, a car control, or a smart speaker) to execute the corresponding instruction.

BERT, the full name of Bidirectional Encoder Representations from Transformers, is a pre-trained language model based on a Transformer architecture. The BERT learns language knowledge from mass text data through large-scale unsupervised training, and can then be configured for various nature language processing tasks.

A generative large language model (LLM) refers to a deep learning generative model trained with mass text data, and can generate a nature language text or understand the meaning of a language text. The large language model may process various nature language tasks, such as text classification, question answering, and dialog, and is an important way to artificial intelligence. Common big language models include ChatGPT, Llama, Bloom, and the like.

Chain-of-thought (CoT) refers to a method of training a model to learn based on human thinking patterns to break down a complex problem into a plurality of sub-steps and ultimately obtaining correct results through step-by-step inference. The CoT can promote the inference capability of the model in face of complex problems.

The spoken language request may be an oral language request transmitted by a user to a machine or device, such as a voice command or oral question. Through the voice command or oral question, the user may interact with an intelligent assistant or voice interaction system, and various functions can be implemented according to user's needs. The spoken language request may include, but is not limited to, a single-intent request, a one-language and multi-intent request, a multi-round intent request, or the like.

The single-intent request refers to a round of spoken language request transmitted to the machine or device, and the spoken language request only includes one intent in one domain. For example, the spoken language request is “I want to turn on the air conditioning”. It can be seen that the spoken language request includes one intent “turn on the air conditioning” in the “device control” domain.

The one-language and multi-intent request refers to a round of spoken language request transmitted to the machine or device, and the request only includes 2 or more than 2 domains and intents, and specifically includes respective intents in 2 or more than 2 domains, or 2 or more than 2 intents in one domain. For example, the spoken language request is “I want to turn on the air conditioning and navigate to the company”. It can be seen that the spoken language request includes one intent “turn on the air conditioning” in the “device control” domain and one intent “navigate to the company” in the “navigation” domain.

The multi-round intent request refers to multiple rounds of spoken language requests transmitted to the machine or device, where the current round of spoken language request is associated with other spoken language requests previous to the current round. For example, the multi-round intent request includes another round of spoken language request:
“How is the weather today” and the current round of request: “How about tomorrow?”.

The specific implementations of this application involve relevant data such as user's spoken language requests, training datasets, sample texts, target speech, and spoken language request texts. When the following embodiments of this application are applied to specific products or technologies, permission or consent is required, and the collection, use, and processing of the relevant data need to comply with applicable laws, regulations, and standards of relevant countries and regions.

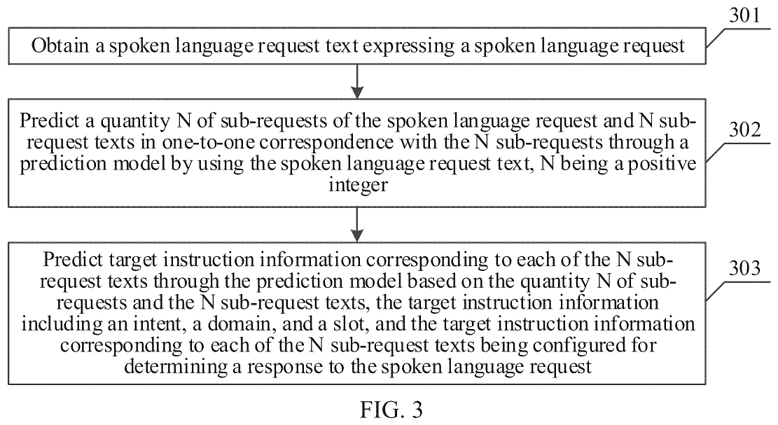

In an embodiment, a text processing method involving artificial intelligence technology is provided. The method may be applied to the electronic device in FIG. 2. As shown in FIG. 3, a specific process of the text processing method may be as follows:
301: Obtain a spoken language request text expressing a spoken language request.

The spoken language request text expresses the spoken language request. The spoken language request refers to a request expressed in spoken language, and the spoken language request may be expressed in a voice form. The spoken language request may be targeted at a controllable object, and is used to request the controllable object to perform some operations. The spoken language request may include one or more sub-requests, without limitation herein. The controllable object may be controlled, including a vehicle terminal, a mobile phone, a remote server, a sensor, or the like. For example, the controllable object may be a vehicle terminal, and the spoken language request may request the vehicle terminal to display weather information, play navigation information, or control in-vehicle temperature.

In some embodiments, the spoken language request text may be obtained by transforming the spoken language request. The speech scenario may refer to a spoken language understanding scenario, in which the electronic device may receive a user's spoken language request and parse and understand the request through nature language processing technology, to perform corresponding operations or provide accurate answers. In this embodiment, the speech scenario may include, but is not limited to, a single-intent request scenario, a multi-intent request scenario, or a multi-round request scenario.

The spoken language request text is a text of a spoken language request in the single-intent request scenario, a text of a spoken language request in the multi-intent request scenario, or a text of one round of spoken language request in the multi-round request scenario.

The text in the single-intent request scenario (hereinafter also referred to as a single-intent scenario) includes a single-intent request content, and the single-intent request content represents a request content including one intent.

As an example, the single-intent request content is “I want to turn on the air conditioning”, where the request content only includes one intent “turn on the air conditioning”.

The text in the multi-intent request scenario (hereinafter also referred to as a multi-intent scenario) includes a multi-intent request content, which represents a request content including multiple intents.

The multi-intent request may refer to the foregoing one-language and multi-intent request. As an example, the multi-intent request content may be “I want to turn on the air conditioning and navigate to the company”, where the request content includes one intent “turn on the air conditioning” and one intent “I want to go to the company”.

The text in the multi-round request scenario (hereinafter also referred to as a multi-round scenario) includes a text of a current round and texts of rounds previous to the current round.

The multi-round request may refer to the foregoing multi-round intent request. For example, the user issues a first round of spoken language request: “I want to book a flight from location A to location B tomorrow afternoon.”; the electronic device answers: “Okay, do you need economy class or business class?”; and the user issues a second round (such as a current round) of spoken language request: “Economy class”. The text corresponding to the first round of spoken language request is a text of a round previous to the current round. The text corresponding to the second round of spoken language request is a text of the current round. The single-intent scenario refers to a scenario where the spoken language request issued by the user is the foregoing single-intent request. The multi-intent scenario refers to a scenario where the spoken language request issued by the user is the foregoing one-language and multi-intent request.
302: Predict a quantity N of sub-requests of the spoken language request and N sub-request texts in one-to-one correspondence with the N sub-requests through a prediction model by using the spoken language request text, N being a positive integer.

The spoken language request may include one or more sub-requests, which may be configured for requesting the foregoing controllable object to perform some corresponding operations.

The prediction model may be pre-trained through chain-of-thought. Since the chain-of-thought is a method of training a model to learn based on human thinking patterns to break down a complex problem into a plurality of sub-operations and ultimately obtaining correct results through step-by-step inference, in this embodiment, the prediction model can learn how to predict the quantity N of sub-requests in the spoken language request text and break down the spoken language request text into N sub-request texts through chain-of-thought training.
303: Predict target instruction information corresponding to each of the N sub-request texts through the prediction model based on the quantity N of sub-requests and the N sub-request texts, the target instruction information including an intent, a domain, and a slot, and the target instruction information corresponding to each of the N sub-request texts being configured for determining a response to the spoken language request.

The prediction model may be obtained by training a generative large language model. Therefore, the prediction model trained in conjunction with preset indication information may predict the target instruction information corresponding to each of the N sub-request texts based on the quantity N of sub-requests and the N sub-request texts. The indication information may indicate that the generative large language model outputs the target instruction information including an intent, a domain, and a slot. The prediction model may predict a piece of target instruction information for each of the N sub-request texts.

In some implementations, before operation 302, the text processing method may further include a training method for the prediction model. The training method for the prediction model may include the following operations:
S1: Obtain a training dataset in a plurality of scenarios, the training dataset including at least one sample text corresponding to each scenario, and the plurality of scenarios including at least two of the single-intent request scenario, the multi-intent request scenario, and the multi-round request scenario.

The sample text may be obtained from the user's spoken language request through speech recognition and conversion. Therefore, the speech scenario corresponding to the spoken language request is also the speech scenario corresponding to the sample text transformed from the spoken language request.

In some implementations, a specific implementation of obtaining a training dataset in a plurality of speech scenarios may include: obtaining a plurality of spoken language request samples, labeling a type of each spoken language request sample, then transforming each spoken language request sample into a corresponding sample text through speech recognition, and then establishing a corresponding relationship between the sample text and the speech scenario based on the type of the spoken language request sample corresponding to the sample text. For example, when the type of the spoken language request corresponding to the sample text is a one-language and multi-intent request, a corresponding relationship may be established between the sample text and the multi-intent request scenario. For another example, when the type of the spoken language request corresponding to the sample text is a single-intent request, a corresponding relationship may be established between the sample text and the single-intent request scenario. For yet another example, when the type of the spoken language request corresponding to the sample text is a multi-round intent request, a corresponding relationship may be established between the sample text and the multi-round request scenario. Therefore, the training dataset in the plurality of speech scenarios is obtained. The plurality of spoken language request samples may be extracted from historical dialog records recorded by the electronic device, or automatically generated by the electronic device based on a preset spoken language request template, without limitation herein.

In some implementations, in operation S1, a specific implementation of obtaining a training dataset in a plurality of scenarios may include:
S11: Obtain a first-round dialog template set and at least one sub-round dialog template set, each first-round dialog template in the first-round dialog template set and each sub-round dialog template in the sub-round dialog template set including blank slots.

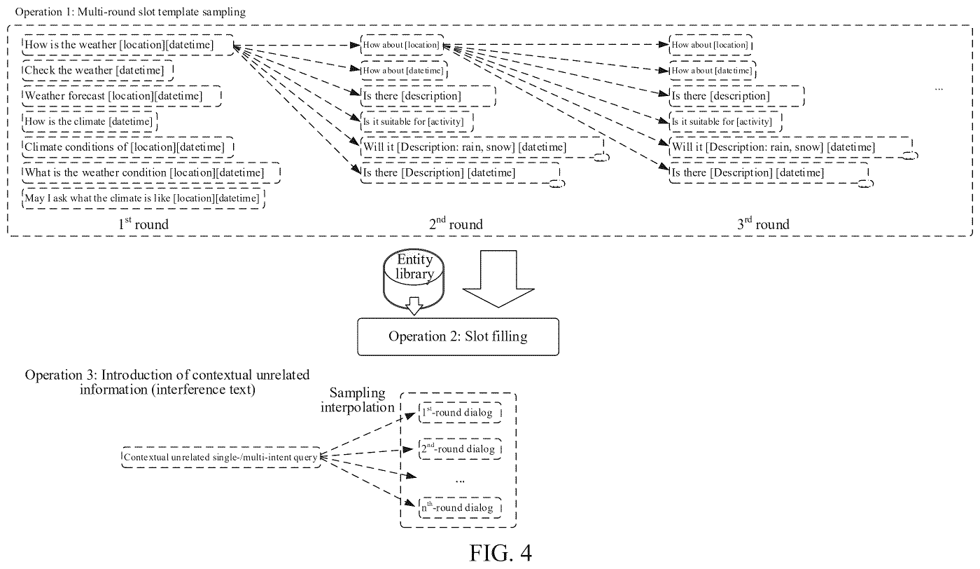

The first-round dialog template set includes at least one first-round dialog template, which may be a pre-labeled question template including blank slots. The blank slots may be regarded as locations left to be filled or supplemented in a dialog. These locations need to be filled in with appropriate information based on the context or prompts provided by the question. As shown in FIG. 4, the first-round dialog template may be “How is the weather [location] [datetime]”, which means how is the weather at a time and a place, where [location] and [datetime] are blank slots, [location] represents location and address, and [datetime] represents date and/or time.

Each sub-round dialog template set includes at least one sub-round dialog template, which may include a reference template, an omission template, or the like, where the omission template is used to omit duplicate information in the dialog. When a piece of information is explicitly mentioned in the context, the dialog may be simplified through the omission template and only new or modified information is provided. The reference template is configured for replacing previously mentioned information with specific words or phrases in the dialog, to reduce repetition and improve communication efficiency. Following the above example, the sub-round dialog template may be “How about [location]”. Combined with the first-round dialog template “How is the weather [location] [datetime]” in the above example, the sub-round dialog template is an omission template obtained by omitting “the weather” based on the first-round dialog template. Refer to FIG. 4 again. In addition to [location] and [datetime], the blank slots may further include [activity], [description], and the like. The [activity] represents an activity or the like, and the [description] represents a description object. For example, the sub-round dialog template set includes “Is it suitable for [activity]”, which means whether the weather is suitable for an activity. For another example, the sub-round dialog template set includes “Is there [description] [datetime]”, which means there will be a description object at some time. The description object may be snow, rain, or the like.

In some implementations, the first-round dialog template set and the at least one sub-round dialog template set may be pre-labeled and stored in a preset template database. When the electronic device needs to construct training data in a multi-round scenario through the dialog templates in the preset template database, the electronic device can retrieve the required first-round dialog template set and at least one sub-round dialog template set from the preset template database. The preset template database may be set locally in the electronic device or in a cloud device connected to the electronic device by communication, without limitation herein.
S12: Combine each first-round dialog template in the first-round dialog template set with each sub-round dialog template in the sub-round dialog template set respectively to obtain a plurality of dialog combinations.

For example, refer to FIG. 4 again. Taking one first-round dialog template set and two sub-round dialog template sets (sub-round dialog template set 1 and sub-round dialog template set 2) as an example, the first-round dialog template set includes 7 first-round dialog templates, the sub-round dialog template set 1 includes 6 sub-round dialog templates, and the sub-round dialog template set 2 includes 6 sub-round dialog templates. Each first-round dialog template in the first-round dialog template set is combined with the 6 sub-round dialog templates in the sub-round dialog template set 1 to obtain 42 dialog combinations. Afterwards, the 42 dialog combinations may be further combined with the 6 sub-round dialog templates in the sub-round dialog template set 2 to obtain 42*6 dialog combinations. Similarly, when there are more than 2 sub-round dialog template sets, the sub-round dialog templates therein can be combined in the above way to obtain more dialog combinations.

In some implementations, when the first-round dialog templates are combined with the sub-round dialog templates, a dialog round order of each round of dialog template set may be preset (such as a second round, a third round, or the like), and then the sub-round dialog templates in each round of dialog template set may be combined with the first-round dialog templates according to the dialog round order. For example, the first-round dialog template selected from the first-round dialog template set (1^{st} round in FIG. 4) is “How is the weather [location] [datetime]”, the sub-round dialog template selected from the second sub-round dialog template set (2^{nd} round in FIG. 4) is “How about [location]”, and the sub-round dialog template selected from the third sub-round dialog template set (3^{rd} round in FIG. 4) is “How about [datetime]”. The three rounds of dialog templates are combined to obtain a dialog combination: the first-round dialog “How is the weather [location] [datetime]”, the second-round dialog “How about [location]”, and the third-round dialog “How about [datetime]”.
S13: Extract entity information from a preset entity library based on the blank slots in the dialog combinations.

The entity information represents critical information in nature language processing technology, generally divided into two types: information that is basically unrelated to services and may be considered as general information, such as phone number, email, date, time, and address; and information that is related to services and customized according to actual scenarios.

In some implementations, entity information of divided entity categories (such as person name, place name, date, institution name, or others) may be pre-stored in the preset entity library, and then entity information of a corresponding entity category may be selected from the entity library based on the meaning represented by the blank slot. For example, for the blank slot [datetime], which represents the meaning of time, the entity information corresponding to the date (such as March 9) may be extracted from the entity library.
S14: Fill the entity information into the dialog combinations to obtain a training dataset in the multi-round request scenario.

Following the above example, the first-round dialog template in the dialog combination is “How is the weather [location] [datetime]?”, where the entity information selected for [location] represents the “location A” of a city, and the entity information selected for [datetime] is “March 9”. The entity information is filled into the first-round dialog template to obtain a first-round dialog text “How is the weather at location A on March 9”. Similarly, the corresponding entity information is filled into the sub-round dialog template of this dialog combination in the above way to obtain a filled dialog combination. Then, the filled dialog combination is designated as the training dataset in the multi-round scenario.

Considering scarce training datasets and high labeling costs in the multi-round scenario, in this implementation, the first-round dialog template set and the sub-round dialog template set are obtained and combined to obtain dialog combinations, and then blank templates of each dialog template in the dialog combinations are filled to obtain the training dataset in the multi-round scenario. Therefore, by labeling a small number of dialog templates, a large number of training datasets in the multi-round scenario can be obtained, which can enhance the subsequent training effect on the multi-round scenario in the initial prediction model.

In some implementations, in operation S14, a specific implementation of filling the entity information into the dialog combinations to obtain a training dataset in the multi-round request scenario may include:
S141: Fill the entity information into the dialog combinations to obtain multi-round dialog sample texts.

After the plurality of dialog combinations are obtained, for each dialog combination, corresponding entity information may be filled into the blank slots of the dialog combination to obtain a multi-round dialog sample text corresponding to the dialog combination. For example, the specific filling into the blank slots may refer to the example in operation S4. For example, the obtained multi-round dialog sample text may be: first-round “How is the weather at location A on March 9”, second-round “How about location B”, and third-round “How about March 10”.
S142: Obtain at least one interference text, and interpolate the at least one interference text into the multi-round dialog sample texts to obtain target multi-round dialog sample texts.

For one multi-round dialog sample text, the interference text may be unrelated to each round of dialog content in the multi-round dialog sample text. The interference texts may include texts corresponding to single-intent requests and texts corresponding to multi-intent requests.

In some implementations, the interference texts may be pre-labeled and stored in a preset text database, and the electronic device may retrieve required interference texts from the preset text database, where the interference texts may be labeled with types (such as person names or place names). An association relationship may be pre-established between the type of an interference text and the type of a blank slot. Specifically, the type of a blank slot may be pre-associated with the type of one or more unrelated interference texts. Therefore, after determining the type of a blank slot, the electronic device may filter the corresponding interference text from the preset text database according to the type of the blank slot.

Then, the interference text may be interpolated into the multi-round dialog sample text. Following the above example, the multi-round dialog sample text includes the first-round dialog “How is the weather at location A on March 9”, the second-round dialog “How about location B”, and the third-round dialog “How about March 10”, the interference texts may include interference text 1 (such as someone's phone number) and interference text 2 (such as the postal code of a location). The interference text 1 may be interpolated between the first-round dialog and the second-round dialog, and the interference text 2 may be interpolated between the second-round dialog and the third-round dialog, thereby obtaining a target multi-round dialog sample text. One or more interference texts may be interpolated between two adjacent rounds. Qn in FIG. 4 represents the N^{th} round of dialog, where n is a positive integer.
S143: Designate the target multi-round dialog sample texts as the training dataset in the multi-round request scenario.

In this implementation, unrelated interference texts are interpolated into the multi-round dialog sample texts to obtain the target multi-round dialog sample texts, and the target multi-round dialog sample texts are designated as the training dataset in the multi-round scenario, thereby enhancing the context understanding capability of the initial prediction model when the model is subsequently trained with the training dataset.
S2: Predict a quantity M of sample sub-requests and texts of the M sample sub-requests through an initial prediction model based on the sample text, where M is a positive integer.

The initial prediction model may refer to a to-be-trained generative large language model, and parameters of the large language model have not been determined, so training is required through the sample text to obtain the prediction model. In this embodiment, a plurality of training tasks may be established in the initial prediction model based on different speech scenarios (such as a single-intent scenario, a multi-intent scenario, and a multi-round scenario), and the plurality of training tasks may be jointly trained.

The sample text of the spoken language request in the single-intent request scenario includes a single-intent request content, and the single-intent request content represents a request content including one intent. The quantity M of sample sub-requests is equal to a quantity 1 of intents in the single-intent request content, and the texts of the sample sub-requests are obtained based on the single-intent request content.

The sample text of the spoken language request in the multi-intent request scenario includes a multi-intent request content, and the multi-intent request content represents a request content including a plurality of intents.

The sample text in the multi-round request scenario includes a text of a current round and texts of rounds previous to the current round.

In some implementations, the sample text of the spoken language request in the single-intent request scenario includes a plurality of single-intent request contents. Operation S2 of predicting a quantity M of sample sub-requests and texts of the M sample sub-requests through an initial prediction model based on the sample text may include:
concatenating the plurality of single-intent request contents to obtain a concatenated content.

For example, when the sample text of the spoken language request in the single-intent request scenario, inputted to the initial prediction model, includes: sample text 1 (such as the current round: Please turn off the frequency modulation (FM) radio), sample text 2 (such as the current round: Continuously zoom in the map), and sample text 3 (such as the current round: Where is the nearest Bank of Communications), the plurality of single-intent request contents included in the sample text of the spoken language request in the single-intent request scenario may be directly concatenated into a concatenated content including the plurality of sample texts, where the concatenated content may be “current round: sample text 1, sample text 2, and sample text 3 (such as: Please turn off the FM radio, continuously zoom in the map, and where is the nearest Bank of Communications)”.

The above concatenating operation may alternatively be implemented by performing corresponding chain-of-thought training on the initial prediction model.

In this embodiment, the plurality of single-intent request contents are concatenated to obtain a concatenated content, and the initial prediction model is trained based on the concatenated content, which can improve the spoken language understanding decoupling capability of the initial prediction model and avoid over-fitting in local small sample domain intent training, thereby improving the training efficiency of the generative large language model.

The quantity M of sample sub-requests and the texts of the M sample sub-requests are predicted through the initial prediction model based on the concatenated content, where the quantity M of sample sub-requests is equal to a quantity of single-intent request contents, and the text of each sample sub-request is obtained based on a single-intent request content.

Following the above example, the concatenated content is “Please turn off the FM radio, continuously zoom in the map, and where is the nearest Bank of Communications”. By predicting the quantity M of sample sub-requests and the texts of the M sample sub-requests through the initial prediction model based on the concatenated content, it may be obtained that the quantity M of sample sub-requests is 3, where the texts of the 3 sample sub-requests are: “Please turn off the FM radio”, “Continuously zoom in the map”, and “Where is the nearest Bank of Communications”.

In other implementations, for the sample text of the spoken language request in the multi-intent request scenario, operation S2 of predicting a quantity M of sample sub-requests and texts of the M sample sub-requests through an initial prediction model based on the sample text may include:
predicting the quantity M of sample sub-requests in the sample text of the spoken language request in the multi-intent request scenario and the texts of the M sample sub-requests through the initial prediction model, the quantity M of sample sub-requests being equal to a quantity of intents in the multi-intent request content, and the text of each sample sub-request being obtained based on request content of one intent in the multi-intent request content.

For example, for the sample text of the spoken language request in the multi-intent request scenario, the sample text may be decomposed through the initial prediction model to obtain the texts of the M sample sub-requests.

For example, the initial prediction model may first recognize the quantity of intents in the sample text. Taking the sample text “Open XX application and set the volume of the vehicle to 5” as an example, through intent recognition on the sample text, it may be recognized that the sample text includes request contents of 2 intents: “Open XX application” and “Set the volume of the vehicle to 5”. Then, the initial prediction model may decompose the sample text into texts of two sample sub-requests based on the 2 intents: “Open XX application” and “Set the volume of the vehicle to 5”.

The foregoing decomposition operation may alternatively be implemented by performing corresponding chain-of-thought training on the initial prediction model, so that the model has a chain-of-thought decomposition capability.

In some other implementations, for the sample text in the multi-round request scenario, operation S2 of predicting a quantity M of sample sub-requests and texts of the M sample sub-requests through an initial prediction model based on the sample text may include:

A1: Merge the text of the current round with the texts of the rounds previous to the current round to obtain a merged text, the merged text being configured for representing the text of the current round and the texts of the rounds previous to the current round.

The current round may be a last round in a plurality of rounds, for example, if the plurality of rounds include a first round, a second round, and a third round, the third round may be determined as the current round.

For example, the first round: “How long did AAA live”, where AAA is a historical figure; the second round: “50 years old, I'm sure”; and the current round: “Why”. The text of the current round is “Why”, and the texts of the rounds previous to the current round include “How long did AAA live” and “50 years old, I'm sure”.

As an implementation, operation AI of merging the text of the current round with the texts of the rounds previous to the current round to obtain a merged text may include:
extracting key information associated with the text of the current round from the texts of the rounds previous to the current round, the key information including at least one of keywords and key sentences.

Following the above example, based on the overall semantics represented by the three rounds of texts, the key sentence “AAA live” may be extracted from the text of the first round “How long did AAA live” in the texts of the rounds previous to the current round, and the key words “50 years old” and “sure” may be extracted from the text of the second round “50 years old, I'm sure”.

The key information is merged with the text of the current round to obtain the merged text.

Following the above example, the keywords “50 years old” and “sure”, the key sentence “AAA live”, and the current sample text “Why” may be merged to obtain the merged text: “Why sure AAA lived 50 years”.

Considering that in multi-round dialog texts, the current sample text corresponding to the current round is usually the most important, and candidate sample texts corresponding to other rounds may only be partially related to the current sample text, in this implementation, the key information associated with the text of the current round is extracted from the texts of the rounds previous to the current round, and the key information is merged with the text of the current round to obtain the merged text, thereby improving the efficiency and accuracy of merging.

A2: Predict the quantity M of sample sub-requests and the texts of the M sample sub-requests through the initial prediction model based on the merged text, the quantity M of sample sub-requests being equal to a quantity 1 of text of the current round, and the texts of the sample sub-requests being obtained by processing the text of the current round in combination with the texts of the rounds previous to the current round.

Following the above example, the merged text “Why sure AAA lived 50 years”, the merged text obtained by merging the texts of rounds includes only one final request. Therefore, through the initial prediction model, based on the merged text, the quantity M of sample sub-requests is predicted to be 1.

Therefore, the prediction efficiency can be effectively improved by merging the sample texts in the multi-round request scenario through the initial prediction model to obtain the merged text, and then predicting the quantity M of sample sub-requests and the texts of the M sample sub-requests through the initial prediction model based on the merged text.

The foregoing merging operation may alternatively be implemented by performing corresponding chain-of-thought training on the initial prediction model, whereby the model has a chain-of-thought merging capability.

In some implementations, in operation 302, a specific implementation of predicting a quantity N of sub-requests of the spoken language request and N sub-request texts in one-to-one correspondence with the N sub-requests through a prediction model by using the spoken language request text may include:
generating input information based on preset prompt information and the sample text, the preset prompt information including task description information corresponding to the predicted instruction information.

For example, the preset prompt information may be “The following is an instruction describing a task, accompanied by an input providing more information. Write an answer that can fulfill the request”.

The input information is inputted into the initial prediction model, and the quantity M of sample sub-requests and the texts of the M sample sub-requests are predicted through the initial prediction model based on the sample text.

In some other implementations, the sample text is a spoken language text, and in operation 302, a specific implementation of predicting a quantity N of sub-requests of the spoken language request and N sub-request texts in one-to-one correspondence with the N sub-requests through a prediction model by using the spoken language request text may include:
generating the input information based on the spoken language text, the preset prompt information, and preset indication information, the preset indication information being configured for indicating the initial prediction model to output instruction information, and the instruction information including an intent, a domain, and a slot.

For example, the preset indication information may be: “Suppose you are an intelligent voice assistant. You need to perform semantic parsing on inputted multi-round user requests and output the domain, intent, and slot corresponding to the current round of request”.

The spoken language text may be obtained by transforming or translating the spoken language request. For example, the spoken language request may be “Where is the nearest Bank of Communications”.
S3: Predict instruction information of the sample text in the corresponding scenario through the initial prediction model based on the quantity M of sample sub-requests and the texts of the M sample sub-requests, to obtain predicted instruction information.

In some implementations, in operation S3, a specific implementation of predicting instruction information of the sample text in the corresponding scenario through the initial prediction model based on the quantity M of sample sub-requests and the texts of the M sample sub-requests, to obtain predicted instruction information, may include:
S31: Match the texts of the M sample sub-requests with a preset entity library respectively to obtain entity information corresponding to each sample sub-request.

The entity information corresponding to the sample text may be obtained from the preset entity library through maximum matching of entities, where the maximum matching of entities is a technology for text processing and nature language processing. This technology is mainly designed to recognize and extract entities (such as person names, places, and organizations) that appear in a given text. The basic idea of the maximum matching of entities is to segment the to-be-processed text based on a lexicon or rule and then gradually match longest possible entities from left to right. In this way, consecutive words can be better recognized and combined into entities. For example, for the sentence: “I like the products of Company C.”, “Company C” may be recognized as an organization entity by using the maximum matching of entities.

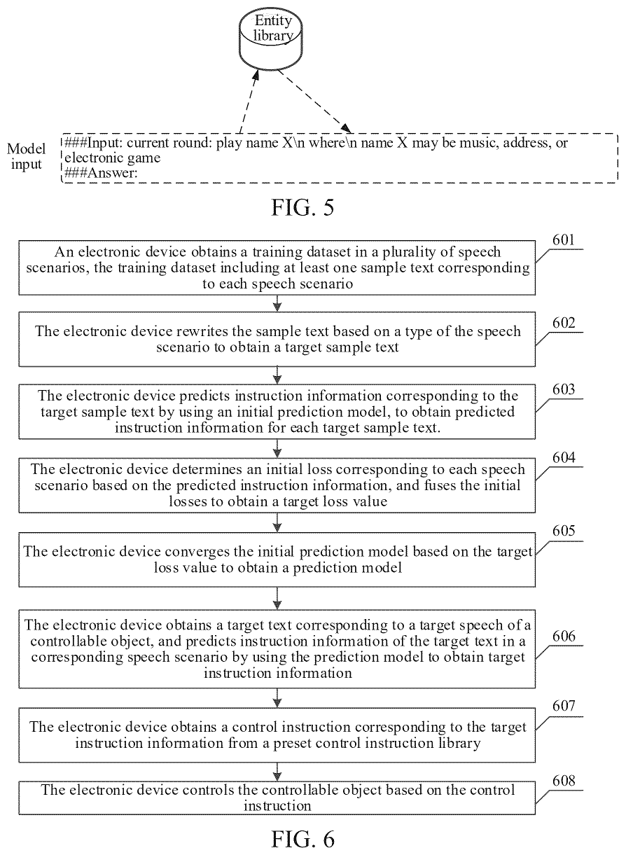

As an example, as shown in FIG. 5, the sample text of the current round is “play name X”. If the preset entity library stores entity information about name X including “music: name X”, “address: name X”, and “electronic game: name X”, the “music: name X”, “address: name X”, and “electronic game: name “X” may all be taken as entity information corresponding to the sample text.
S32: For each sample sub-request, update the sample sub-request based on the entity information corresponding to the sample sub-request to obtain an updated sample sub-request.

Following the above example, a supplementary description of the sample text “play name X” may be generated based on the “music: name X”, “address: name X”, and “electronic game: name “X”, and the supplementary description is added to the sample text to obtain the updated sample text (such as “play name X, where name X may be music, address, or electronic game”).

The foregoing updating operation may alternatively be implemented by performing corresponding chain-of-thought training on the initial prediction model. \n in FIG. 5 represents line feed, and the answer may be a sample text with updated labels. The sample text with updated labels and the updated sample text may be used to perform corresponding chain-of-thought training on the initial prediction model, thereby training the chain-of-thought updating capability of the model.
S33: Predict the instruction information of the sample text in the corresponding scenario through the initial prediction model based on the updated sample sub-requests, to obtain the predicted instruction information.

In this implementation, the sample sub-requests are matched with the preset entity library to obtain the entity information corresponding to the sample sub-requests, the sample sub-requests are updated based on the entity information to obtain the updated sample sub-requests, the instruction information is predicted for the initial prediction model based on the updated sample sub-requests, and when the obtained prediction results are applied to model training, the prediction accuracy of the model can be effectively improved.
S4: Train the initial prediction model based on the predicted instruction information to obtain the prediction model.

In some implementations, in operation S4, a specific implementation of training the initial prediction model based on the predicted instruction information to obtain the prediction model may include:
S41: Determine an initial loss value corresponding to each of the plurality of scenarios based on the predicted instruction information.

In some implementations, the sample text includes a negative sample text and a positive sample text, the negative sample text includes a sample text in a mislabeled domain, and the positive sample text includes a sample text except the negative sample text in the sample text. In operation S41, a specific implementation of determining an initial loss value (hereinafter also referred to as initial loss) corresponding to each of the plurality of scenarios based on the predicted instruction information may include:
S411: Filter predicted instruction information corresponding to the positive sample text from the predicted instruction information to obtain positive sample instruction information.

For example, the negative sample text may be a sample labeled with “not belonging to domain x”. In practical application, to simplify labeling, the label about “not belonging to domain x” may be set to “0”. Then, among a plurality of sample texts, those without “0” may be regarded as positive sample texts. Since the predicted instruction information is the output of the initial prediction model for all the sample texts, the predicted instruction information includes predicted instruction information corresponding to positive sample texts and predicted instruction information corresponding to negative sample texts. The predicted instruction information corresponding to the positive sample text may be filtered from the predicted instruction information and used as the positive sample instruction information. The positive sample instruction information may further include Pₚₒₛ, where Pₚₒₛ represents a probability that the initial prediction model outputs the positive sample instruction information.
S412: Filter predicted instruction information corresponding to the negative sample text from the predicted instruction information to obtain negative sample instruction information, and adjust the negative sample instruction information to obtain target negative sample instruction information.

The predicted instruction information corresponding to the negative sample text may be filtered from the predicted instruction information and used as the negative sample instruction information. The negative sample instruction information may further include P_{neg}, where P_{neg} represents a probability that the initial prediction model outputs the negative sample instruction information, or a prediction probability of the label “0”.

The negative sample instruction information is adjusted to obtain the target negative sample instruction information. Specifically, the probability of “not belonging to domain x” in the negative sample instruction information may be adjusted to 1−P_{neg}.
S413: Determine the initial loss value corresponding to each scenario based on the positive sample instruction information and the target negative sample instruction information.

A specific implementation of operation S413 may include:
S4131: Obtain positive sample labeling instruction information corresponding to the positive sample text and negative sample labeling instruction information corresponding to the negative sample text.

The positive sample labeling instruction information serves as a reference for the positive sample instruction information outputted by the initial prediction model based on the positive sample text, and serves as a target value of the positive sample instruction information. Therefore, the training performance of the initial prediction model can be determined by comparing the positive sample labeling instruction information with the positive sample instruction information. Similarly, the negative sample labeling instruction information serves as a reference for the negative sample instruction information outputted by the initial prediction model based on the negative sample texts, and serves as a target value of the negative sample instruction information. Therefore, the training performance of the initial prediction model can be determined by comparing the negative sample labeling instruction information with the negative sample instruction information. The positive sample labeling instruction information corresponding to each positive sample text and the negative sample labeling instruction information corresponding to each negative sample text may be pre-stored in the foregoing training dataset, and can then be obtained from the training dataset.
S4132: Determine a positive sample loss corresponding to each scenario based on the positive sample labeling instruction information and the positive sample instruction information.

The positive sample loss is computed to evaluate the prediction accuracy or the degree of error of the initial prediction model. Since the positive sample labeling instruction information serves as the target value of the positive sample instruction information, an error value between the positive sample labeling instruction information and the positive sample instruction information may be determined by comparing the positive sample labeling instruction information with the positive sample instruction information, and the positive sample loss may be determined based on the error value. Specifically, a common loss function, such as mean squared error, cross entropy, or absolute error, may be employed for computing.
S4133: Determine a negative sample loss corresponding to each scenario based on the negative sample labeling instruction information and the negative sample instruction information.

A specific implementation of determining a negative sample loss corresponding to each scenario based on the negative sample labeling instruction information and the negative sample instruction information in operation S4133 may include:
determining an initial negative sample loss of a target sample text corresponding to the negative sample based on the negative sample labeling information and the negative sample instruction information.

For example, for each of the plurality of speech scenarios, a plurality of sample texts corresponding to the speech scenario, and each of the plurality of sample texts, the initial negative sample loss of the sample text may be determined based on the negative sample labeling information and negative sample instruction information corresponding to the sample text. For example, the training dataset corresponding to the single-intent scenario includes sample text 1, sample text 2, and sample text 3, where an initial negative sample loss 1 may be obtained based on the negative sample labeling information and negative sample instruction information corresponding to the sample text 1, an initial negative sample loss 2 may be obtained based on the negative sample labeling information and negative sample instruction information corresponding to the sample text 2, and an initial negative sample loss 3 may be obtained based on the negative sample labeling information and negative sample instruction information corresponding to the sample text 3. For another example, the training dataset corresponding to the multi-intent scenario includes sample text 4 and sample text 5, where an initial negative sample loss 4 may be obtained based on the negative sample labeling information and negative sample instruction information corresponding to the sample text 4, and an initial negative sample loss 5 may be obtained based on the negative sample labeling information and negative sample instruction information corresponding to the sample text 5.

At least one initial negative sample loss in the same scenario is filtered from the initial negative sample losses, to obtain a set of initial negative sample losses corresponding to each scenario.

Following the above example, the initial negative sample loss 1, the initial negative sample loss 2, and the initial negative sample loss 3 may be determined as the set of initial negative sample losses corresponding to the single-intent scenario. The initial negative sample loss 4 and the initial negative sample loss 5 are determined as the set of initial negative sample losses corresponding to the multi-intent scenario.

The initial negative sample losses in the set of initial negative sample losses are fused to obtain the negative sample loss corresponding to each scenario.

Following the above example, for the single-intent scenario, the initial negative sample loss 1, the initial negative sample loss 2, and the initial negative sample loss 3 may be fused to obtain the negative sample loss corresponding to the single-intent scenario. For the multi-intent scenario, the initial negative sample loss 4 and the initial negative sample loss 5 may be fused to obtain the negative sample loss corresponding to the multi-intent scenario. The fusion of the initial negative sample losses may specifically be addition of weights. For example, weights w1, w2, and w3 are pre-configured for the initial negative sample loss 1, the initial negative sample loss 2, and the initial negative sample loss 3, respectively. The negative sample loss corresponding to the single-intent scenario is: initial negative sample loss 1*w1+initial negative sample loss 2*w2+initial negative sample loss 3*w3. w1: w2: w3 may be 1:1:1 or other ratios. The specific ratio may be set according to actual needs, without limitation herein.

In operation S4132, a specific implementation of determining the positive sample loss corresponding to each speech scenario based on the positive sample labeling instruction information and the positive sample instruction information may also refer to operation S4133, so repetition is not provided herein.
S4134: Fuse the positive sample loss and the negative sample loss to obtain the initial loss value corresponding to each scenario.

For example, the positive sample loss and the negative sample loss may be fused through the following formula to obtain the initial loss value corresponding to each speech scenario:

Loss=lossₚₒₛ+λloss_{neg}=−log Pₚₒₛ−λ log(1−P_{neg}),

where Loss represents an initial loss value corresponding to a speech scenario, lossₚₒₛ represents a positive sample loss corresponding to the speech scenario, loss_{neg} represents a negative sample loss corresponding to the speech scenario, and A represents a reverse gradient weight. A may specifically be 0.1 or other values such as 0.2 as needed. The performance of the model trained under different reverse gradient weights may be tested, to select the appropriate reverse gradient weight.
S42: Fuse the initial loss values to obtain a target loss value.

A specific implementation of operation S42 may include:
obtaining a fusion weight corresponding to each speech scenario, weighting the initial losses based on the fusion weight, and fusing the weighted initial losses to obtain the target loss value (hereinafter also referred to as a target loss).

After the initial loss corresponding to each speech scenario is obtained through operation S4134, the fusion weight corresponding to each speech scenario may be obtained from a preset weight database, where the preset weight database includes the fusion weight preset for each speech scenario.

As an example, the fusion weight corresponding to the single-intent scenario is k1, the fusion weight corresponding to the multi-intent scenario is k2, the initial loss corresponding to the single-intent scenario is Loss1, and the initial loss corresponding to the multi-intent scenario is Loss2. Then, it may be determined that the target loss value is (k1*Loss1+k2*Loss2).

In some implementations, a specific implementation of fusing the weighted initial losses to obtain the target loss value may involve performing weighted summation on the initial losses corresponding to each speech scenario, and then solving a mean value of the weighted summation results. For example, the target loss value is (k1*Loss1+k2*Loss2)/2.

After the sample texts in the multi-round request scenario are merged to obtain the merged text, the text processing method may further include:
extracting labeled merged sample texts corresponding to the sample texts in the multi-round request scenario from the training dataset.

For one sample text in the multi-round request scenario, the labeled merged sample text corresponding to the sample text in the multi-round request scenario may be a target value of the merged sample text corresponding to the sample text in the multi-round request scenario.

A merge loss is determined based on the labeled merged sample texts and the merged sample text.

After the labeled merged sample texts and the merged sample text are determined, the merge loss may be determined by referring to the method for computing a loss in operation S4132.

Correspondingly, in operation S42, a specific implementation of fusing the initial loss values to obtain a target loss value may include:
fusing the initial losses and the merge loss to obtain the target loss value.

Following the above example, the merge loss is Loss3, the fusion weight pre-corresponding to the merge loss is L3, and the obtained target loss value may be (k1*Loss1+k2*Loss2+k3*Loss3) or (k1*Loss1+k2*Loss2+k3*Loss3)/3. In this implementation, by fusing the initial loss and the merge loss to obtain the target loss value, the chain-of-thought merging capability of the initial prediction model can be simultaneously trained.

The chain-of-thought concatenating capability, chain-of-thought decomposition capability, and the like of the initial prediction model, mentioned in the foregoing embodiments, may also be trained by way of training the chain-of-thought merging capability.
S43: Converge the initial prediction model based on the target loss value to obtain the prediction model.

The initial prediction model may be optimized by a gradient descent method. For example, a gradient of the initial prediction model may be determined based on the target loss value, and then model parameters of the initial prediction model may be adjusted based on the gradient, thereby enabling the initial prediction model to converge. The gradient is a vector pointing to a direction in which a function has a maximum growth rate at a point, and the magnitude of the gradient represents the maximum growth rate.

In some implementations, in the process of training the initial prediction model, each adjustment of the model parameters of the initial prediction model based on the gradient may be regarded as an iteration. When the number of iterations reaches a preset number, the prediction model may be obtained. The preset number may be determined based on historical training records of the initial prediction model.

In some embodiments, after operation 303, the text processing method may further include:
controlling the controllable object through the target instruction information.

The controlling the controllable object through the target instruction information may include:
obtaining a control instruction corresponding to the target instruction information from a preset control instruction library; and controlling the controllable object based on the control instruction.

A plurality of control instructions are pre-stored in the control instruction library, and a mapping relationship is pre-established between the plurality of control instructions and instruction information. Therefore, the control instruction corresponding to the target instruction information may be obtained from the preset control instruction library, and the controllable object may be controlled based on the control instruction. For example, the obtained target instruction information includes: domain: navigation; intent: query road conditions of a route; and slot: from home to the company. The electronic device may obtain a control instruction “output the route from the starting place (home) to the destination (company)” based on the target instruction information, and transmit the control instruction to the controllable object, to instruct the controllable object to output the route from the starting place (home) to the destination (company). The controllable object may include a vehicle terminal, a mobile phone, or the like. The output method may include, but is not limited to, image display, voice broadcasting, or the like.

In this embodiment, after the spoken language request text expressing the spoken language request is obtained, the quantity N of sub-requests and the N sub-request texts of the spoken language request may be predicted through the prediction model, where N is a positive integer; and then, the target instruction information corresponding to each of the N sub-request texts is predicted through the prediction model based on the quantity N of sub-requests and the N sub-request texts, the target instruction information including an intent, a domain, and a slot, and the target instruction information corresponding to each of the N sub-request texts being configured for determining a response to the spoken language request. Since the quantities of sub-requests included in the texts in different spoken language understanding scenarios are often different, in the embodiments of this application, by predicting the quantity N of sub-requests and the N sub-request texts of the spoken language request through the prediction model, the processing of the texts in different spoken language understanding scenarios may be transformed into the processing of different quantities of sub-requests in the texts, and then the target instruction information corresponding to each of the N sub-request texts is predicted through the prediction model based on the quantity N of sub-requests and the N sub-request texts, thereby solving the problem of processing texts in different spoken language understanding scenarios through only one prediction model, avoiding the operations of training a plurality of models required to support a plurality of spoken language understanding scenarios and continuously iterating the models, greatly reducing the complexity, training cost, and iteration cost of the model, and improving text processing efficiency.

According to the method described in the foregoing embodiments, further detailed explanations will be provided below.

In this embodiment, text processing will be taken as an example to detail the method in the embodiments of this application.

As shown in FIG. 6, a specific process of a text processing method is as follows:
601: An electronic device obtains a training dataset in a plurality of speech scenarios, the training dataset including at least one sample text corresponding to each speech scenario.

Operation 601 may include: obtaining a first-round dialog template set and at least one sub-round dialog template set, each first-round dialog template in the first-round dialog template set and each sub-round dialog template in the sub-round dialog template set including blank slots;
combining each first-round dialog template in the first-round dialog template set with each sub-round dialog template in the sub-round dialog template set respectively to obtain a plurality of dialog combinations;
extracting entity information from a preset entity library based on the blank slots in the dialog combinations; and
filling the entity information into the dialog combinations to obtain a training dataset in the multi-round scenario.

The filling the entity information into the dialog combinations to obtain a training dataset in the multi-round scenario includes:
filling the entity information into the dialog combinations to obtain multi-round dialog sample texts; obtaining at least one interference text, and interpolating the at least one interference text into the multi-round dialog sample texts to obtain target multi-round dialog sample texts; and designating the target multi-round dialog sample texts as the training dataset in the multi-round scenario.

For example, refer to FIG. 4 again. In practical application, an implementation process of operation 601 may include: first manually labeling a small quantity of first-round templates and multi-round domain templates (including referred/omitted templates and complete rewritten templates), where the complete rewritten templates may be configured to train a corresponding chain-of-thought generation capability of an initial prediction model, namely, the capability of automatically generating the training dataset in the multi-round scenario; and then, performing dialog template sampling: firstly, sampling the first-round dialog template set, and then cyclically sampling the sub-round dialog template sets to construct multi-round template data (i.e., the dialog combinations in the foregoing embodiments); secondly, filling entity information into the slots of the multi-round template data; and thirdly, interpolating unrelated texts corresponding to the single-/multi-intent request into the filled multi-round data, to enhance the context understanding capability of the model.
602: The electronic device rewrites the sample text based on a type of the speech scenario to obtain a target sample text.

The rewriting the sample text based on the type of the speech scenario to obtain a target sample text may correspond to operation S2 in the foregoing embodiment:
predicting a quantity M of sample sub-requests and texts of the M sample sub-requests through an initial prediction model based on the sample text, where M is a positive integer. The target sample text may be regarded as a text of the M sample sub-requests.

The speech scenarios include a single-round scenario and a multi-round scenario, and the rewriting the sample text based on a type of the speech scenario to obtain a target sample text includes:
when the speech scenario corresponding to the sample text is the multi-round scenario, transforming the sample text into a candidate sample text corresponding to the single-round scenario, and designating the candidate sample text as the sample text corresponding to the single-round scenario; and when the speech scenario corresponding to the sample text is the single-round scenario, rewriting the sample text based on the intent type of the sample text to obtain the target sample text.

The sample text includes multi-round dialog sample texts, and the transforming the sample text into a candidate sample text corresponding to the single-round scenario includes:
determining a current round from a plurality of rounds, and extracting a current sample text corresponding to the current round and candidate sample texts corresponding to other rounds from the dialog sample texts, the other rounds including rounds except the current round among the plurality of rounds; merging the current sample text with the candidate sample texts to obtain a merged sample text corresponding to the current round; and designating the merged sample text as the sample text corresponding to the single-round scenario.

The merging the current sample text with the candidate sample texts to obtain a merged sample text corresponding to the current round includes: extracting key information associated with the current sample text from the candidate sample texts, the key information including at least one of keywords and key sentences; and merging the key information with the current sample text to obtain the merged sample text corresponding to the current round. The candidate sample texts may be equivalent to the texts of the rounds previous to the current round in the foregoing embodiments.

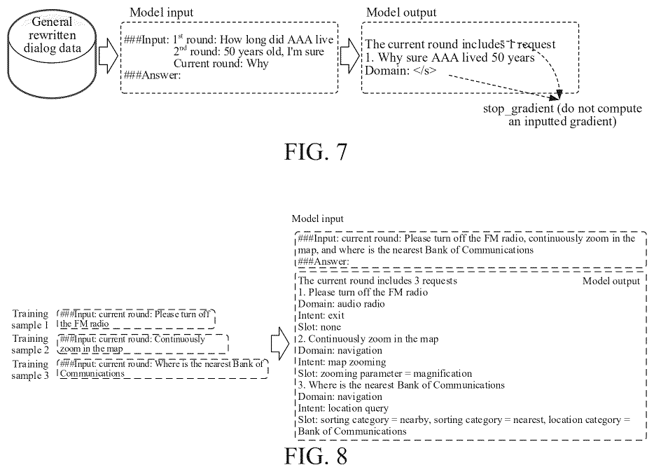

For example, in practical application, as shown in FIG. 7, due to scarce multi-round labeled data and high labeling cost in the multi-round oral language understanding scenario, in order to enhance the capabilities of the generative large language model (initial prediction model) in multi-round user's spoken language request understanding, this embodiment can utilize publicly available general multi-round dialog rewriting data to train the chain-of-thought merging capability of the generative large language model for multi-round spoken language understanding sample texts. For example, during training, a specific input format may be: “###Input: 1^{st} round: {1^{st}-round dialog}\n . . . \n i^{th} round{i^{th}-round dialog}\n current round:{(i+1)th-round dialog}\n ###Answer:”. A specific output format may be: “The current round includes 1 request \n1.{rewritten dialog\n domain: </s>}”. For example, the 1^{st} round of input: How long did AAA live; the 2^{nd} round: 50 years old, I'm sure; and the current round: Why. By merging through the initial prediction model, “Why sure AAA lived 50 years” may be obtained. i is a positive integer. \n represents line feed.

The rewriting the sample text based on an intent type of the sample text to obtain a target sample text includes:
obtaining intent identification information of the sample text, and determining the intent type of the sample text based on the intent identification information; and when the intent type of the sample text is single-intent, concatenating at least one sample text corresponding to the single intent to obtain the target sample text.

For example, as shown in FIG. 8, in order to improve the training efficiency of the generative large language model and avoid over-fitting in locally small sample domain intent training, this embodiment presents a multi-sample concatenating chain-of-thought training strategy. Specifically, during training, 1 to 3 single-intent spoken language understanding training samples may be randomly sampled and organized in an input format:
“###Input: current round: {spoken language request 1}{spoken language request 2}{spoken language request 3}\n ###Answer:”. The intents are constructed in an output format: “The current round includes {n=1,2,3}requests\n 1.{spoken language request 1}domain:
{xxx}\n intent: {xxx}\n slot: {xxx}\n 2. {spoken language request 2}domain: {xxx}\n intent: {xxx}\n slot: {xxx}\n 3.{spoken language request 3}domain: {xxx}\n intent:
{xxx}\n slot: {xxx}”. Sample #1, Sample #2, and Sample #3 represent sample text 1 corresponding to spoken language request 1, sample text 2 corresponding to spoken language request 2, and sample text 3 corresponding to spoken language request 3, respectively.

When the intent types of the sample texts are multi-intent, the sample texts are decomposed to obtain a plurality of text sub-samples, and the text sub-samples are designated as the target sample texts.

The rewriting the sample text based on an intent type of the sample text to obtain a target sample text includes:
obtaining intent identification information of the sample text, and determining the intent type of the sample text based on the intent identification information; when the intent type of the sample text is single-intent, concatenating at least one sample text corresponding to the single intent to obtain the target sample text; and when the intent type of the sample text is multi-intent, decomposing the sample text to obtain a plurality of text sub-samples, and designating the text sub-samples as the target sample text.

The decomposing the sample text to obtain a plurality of text sub-samples includes:
performing text recognition on the sample text, and determining a quantity of domains and a quantity of intents in the sample text based on results of the text recognition;
and decomposing the sample text based on the quantity of domains and the quantity of intents to obtain the plurality of text sub-samples.
603: The electronic device predicts instruction information corresponding to the target sample text by using an initial prediction model, to obtain predicted instruction information for each target sample text.

The initial prediction model predicts the instruction information corresponding to the target sample text to obtain the predicted instruction information for each target sample text may correspond to operation S3 in the foregoing embodiment: predicting instruction information of the sample text in the corresponding scenario through the initial prediction model based on the quantity M of sample sub-requests and the texts of the M sample sub-requests, to obtain predicted instruction information. The predicted instruction information may be regarded as the instruction information of the sample text in the corresponding scenario.

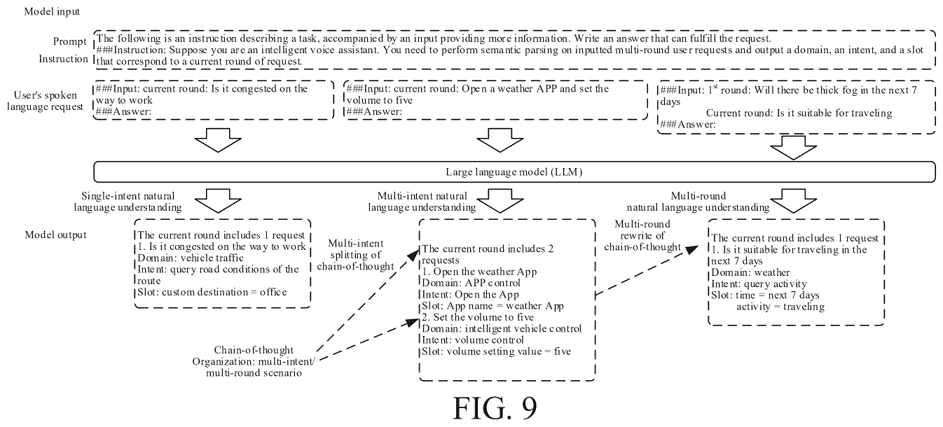

For example, refer to FIG. 9. For the input of training generative large language model, this embodiment may concatenate the user's spoken language request Input, Prompt, and Instruction: Prompt+Instruction+Input. When training in a specific single-/multi-intent spoken language understanding scenario, the spoken language request Input is constructed in a form of “###Input: current round:{user's spoken language request}\n ###Answer:”.

During multi-round spoken language understanding training, the spoken language request Input is constructed in a form of “###Input: 1^{st} round: {xxx} . . . i^{th} round:
{xxx}, current round: {user's spoken language request}\n ###Answer.

The single-intent natural language understanding (NLU) generates the predicted instruction information corresponding to the foregoing single-intent scenario, the multi-intent NLU generates the predicted instruction information corresponding to the foregoing multi-intent scenario, and the multi-round NLU generates the predicted instruction information corresponding to the foregoing multi-round scenario.

The user's spoken language request in this embodiment refers to a text corresponding to the user's spoken language request.
604: The electronic device determines an initial loss corresponding to each speech scenario based on the predicted instruction information, and fuses the initial losses to obtain a target loss value.

For example, the foregoing training dataset may include a large amount of negative sample data (i.e., the foregoing negative sample texts), and the negative sample data includes only labels of “not belonging to domain x” and no labels of “belonging to domain y”. Such data can significantly improve the accuracy of the model and reduce the occurrence of false recalls. In multi-class (2-class) discriminant training, for the negative sample data, the labels in domain x may be directly set to 0. In generative training, this embodiment provides a negative gradient strategy for learning. Specifically, negative sample data output labels may be organized based on positive sample text output labels corresponding to the single-intent scenario, that is, “The current round includes 1 request \n 1. {user's spoken language request}\n domain: {negative sample domain x}</s>” (where “</s>” represents a sentence ending character). Subsequently, when the loss Loss is computed, the prediction probability P_{neg} at the “negative sample domain x” in the generated sequence is transformed into 1−P_{neg}, that is, the model is trained to minimize the prediction probability in the “negative sample domain x”: −log(1−P_{neg}), disabling the model to predict the “negative sample domain x”. At the same time, the ending character “</s>” stops updating the gradient, thereby avoid affecting continued prediction of intent and slot results in positive sample training. The remaining part of the negative sample generation sequence is updated according to the positive sample: −log(Pₚₒₛ).

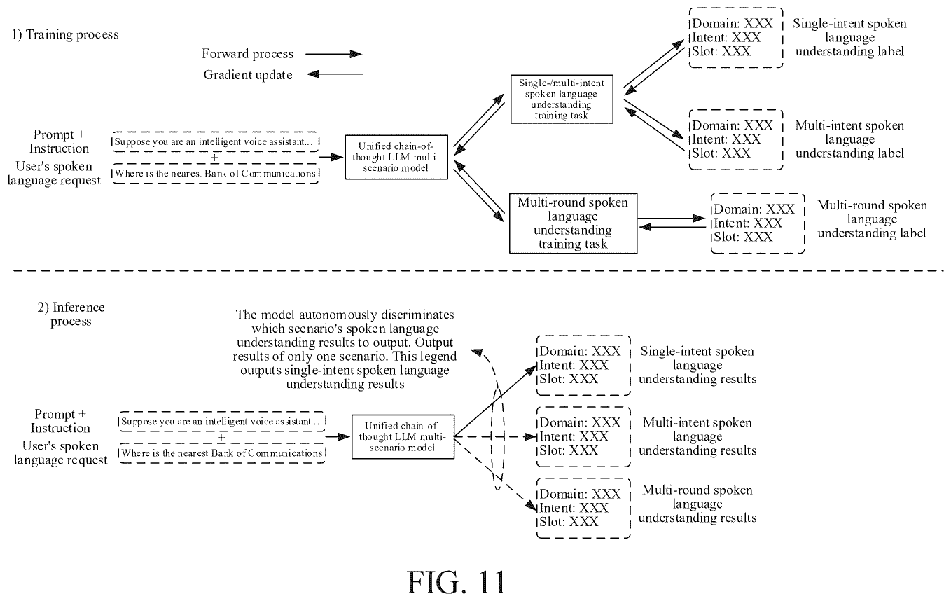

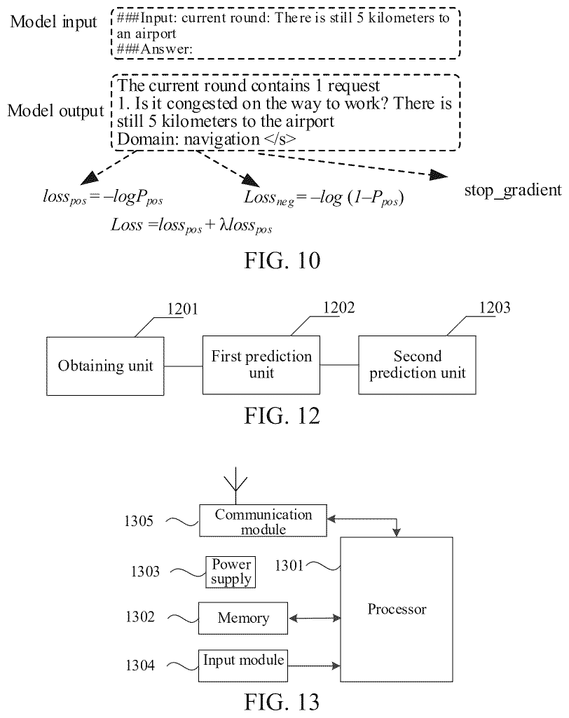

As shown in FIG. 10, the total loss function of negative sample training is expressed as:

Loss=lossₚₒₛ+λloss_{neg}=−log Pₚₒₛ−λ log(1−P_{neg}),

where Loss represents an initial loss corresponding to a speech scenario, lossₚₒₛ represents a positive sample loss corresponding to the speech scenario, loss_{neg} represents the negative sample loss corresponding to the speech scenario, and λ represents a reverse gradient weight. λ may specifically be 0.1 or other values such as 0.2 as needed. The performance of the model trained under different reverse gradient weights may be tested, to select the appropriate reverse gradient weight.

The sample text includes a negative sample text and a positive sample text, the negative sample text includes a sample text in a mislabeled domain, and the positive sample text includes a sample text except the negative sample text in the sample text. The determining an initial loss corresponding to each speech scenario based on the predicted instruction information includes: filtering predicted instruction information corresponding to the positive sample text from the predicted instruction information to obtain positive sample instruction information; filtering predicted instruction information corresponding to the negative sample text from the predicted instruction information to obtain negative sample instruction information, and adjusting the negative sample instruction information to obtain target negative sample instruction information; and determining the initial loss corresponding to each speech scenario based on the positive sample instruction information and the target negative sample instruction information.

The determining the initial loss corresponding to each speech scenario based on the positive sample instruction information and the target negative sample instruction information includes:
obtaining positive sample labeling instruction information corresponding to the positive sample text and negative sample labeling instruction information corresponding to the negative sample text; determining a positive sample loss corresponding to each speech scenario based on the positive sample labeling instruction information and the positive sample instruction information; determining a negative sample loss corresponding to each speech scenario based on the negative sample labeling instruction information and the negative sample instruction information; and fusing the positive sample loss and the negative sample loss to obtain the initial loss corresponding to each speech scenario.

The determining a negative sample loss corresponding to each speech scenario based on the negative sample labeling instruction information and the negative sample instruction information includes:
determining an initial negative sample loss of the target sample text corresponding to the negative sample based on the negative sample labeling instruction information and the negative sample instruction; filtering at least one initial negative sample loss in the same scenario from the initial negative sample losses, to obtain a set of initial negative sample losses corresponding to each scenario; and fusing the initial negative sample losses in the set of initial negative sample losses to obtain the negative sample loss corresponding to each scenario.

After merging the current sample text with the candidate sample texts to obtain the merged sample text corresponding to the current round, the method further includes: extracting labeled merged sample texts corresponding to the multi-round dialog sample texts from the training dataset; and determining a merge loss based on the labeled merged sample texts and the merged sample text. Correspondingly, the fusing the initial losses to obtain a target loss value includes: fusing the initial losses and the merge loss to obtain the target loss value.
605: The electronic device converges the initial prediction model based on the target loss value to obtain a prediction model.
606: The electronic device obtains a target text corresponding to a target speech of a controllable object, and predicts instruction information of the target text in a corresponding speech scenario by using the prediction model to obtain target instruction information.
607: The electronic device obtains a control instruction corresponding to the target instruction information from a preset control instruction library.
608: The electronic device controls the controllable object based on the control instruction.

For example, FIG. 11 shows a training process and an inference process of a prediction model in this embodiment. During the training process, prompt information and indication information in a user's spoken language request (i.e., the foregoing sample texts) are first concatenated, then prediction is performed through the concatenated results through a unified multi-scenario generative large language model (i.e., the foregoing initial prediction model), single-intent spoken language understanding results (i.e., the predicted instruction information corresponding to the foregoing single-intent scenario) and multi-intent spoken language understanding results (i.e., the predicted instruction information corresponding to the foregoing multi-intent scenario) may be obtained through single-/multi-intent spoken language understanding training tasks, and multi-round spoken language understanding results (i.e., the predicted instruction information corresponding to the foregoing multi-round scenario) may be obtained through multi-round spoken language understanding training tasks. Subsequently, the above three types of results are combined with preset single-intent spoken language understanding labels, multi-intent spoken language understanding labels, and multi-round spoken language understanding labels to compute losses of the initial prediction model, and model parameters are updated based on the losses until the prediction model is obtained. During the inference process, the user's spoken language request to be predicted is first inputted into the trained unified chain-of-thought multi-scenario generative large language model (i.e., the foregoing prediction model) for prediction, the prediction model may first determine a speech scenario corresponding to the input data, and then output spoken language understanding results corresponding to the speech scenario based on the input data.

It can be seen that this embodiment combines the generative large language model (LLM) and the chain-of-thought training strategy for unified task modeling on the three scenarios of single-intent spoken language understanding, multi-intent spoken language understanding, and multi-round spoken language understanding, thereby achieving information interaction between different scenarios and mutual complementarity and enhancement of spoken language understanding capabilities, and significantly improving the spoken language understanding effects in cold start scenarios and multi-round scenarios. In addition, the single-model unified integration of a plurality of spoken language understanding scenarios simplifies deployment complexity and language transfer difficulty. At the same time, the generalization capability of the generative large language model is utilized to significantly improve the effects in cold start and low-resource spoken language understanding scenarios. Further, the generalization capabilities and effects in multi-round spoken language understanding scenarios can also be significantly improved. Moreover, in the multi-round spoken language understanding scenarios, this solution can process more contextual problems, thereby significantly enhancing user's multi-round interaction experience with a machine or device.

To better implement the above method, an embodiment of this application further provides a text processing apparatus. The text processing apparatus may specifically be integrated into an electronic device. The electronic device may be a terminal, a server, or the like. The terminal may be a mobile phone, a tablet, a smart Bluetooth device, a laptop, a personal computer, or the like. The server may be a single server or a server cluster composed of a plurality of servers.

For example, in this embodiment, the text processing apparatus is specifically integrated into a text processor to detail the method in the embodiments of this application.

For example, as shown in FIG. 12, the text processing apparatus may include:
an obtaining unit 1201, configured to obtain a spoken language request text expressing a spoken language request;
a first prediction unit 1202, configured to predict a quantity N of sub-requests of the spoken language request and N sub-request texts in one-to-one correspondence with the N sub-requests through a prediction model by using the spoken language request text, N being a positive integer; and
a second prediction unit 1203, configured to predict target instruction information corresponding to each of the N sub-request texts through the prediction model based on the quantity N of sub-requests and the N sub-request texts, the target instruction information including an intent, a domain, and a slot, and the target instruction information corresponding to each of the N sub-request texts being configured for determining a response to the spoken language request.

In some embodiments, the spoken language request text is a text of a spoken language request in a single-intent request scenario, a text of a spoken language request in a multi-intent request scenario, or a text of a round of spoken language request in a multi-round request scenario.

In some embodiments, the text processing apparatus further includes:
a dataset obtaining unit 1201, configured to obtain a training dataset in a plurality of scenarios, the training dataset including at least one sample text corresponding to each scenario, and the plurality of scenarios including at least two of the single-intent request scenario, the multi-intent request scenario, and the multi-round request scenario;
a third prediction unit, configured to predict a quantity M of sample sub-requests and texts of the M sample sub-requests through an initial prediction model based on the sample text, where M is a positive integer;
a fourth prediction unit, configured to predict instruction information of the sample text in the corresponding scenario through the initial prediction model based on the quantity M of sample sub-requests and the texts of the M sample sub-requests, to obtain predicted instruction information; and
a training unit, configured to train the initial prediction model based on the predicted instruction information to obtain the prediction model.

In some embodiments, the sample text of the spoken language request in the single-intent request scenario includes a single-intent request content, and the single-intent request content represents a request content including one intent.

The quantity M of sample sub-requests is equal to a quantity 1 of intents in the single-intent request content, and the texts of the sample sub-requests are obtained based on the single-intent request content.

In some embodiments, the sample text of the spoken language request in the single-intent request scenario includes a plurality of single-intent request contents, and the third prediction unit includes:
a concatenating sub-unit, configured to concatenate the plurality of single-intent request contents to obtain a concatenated content; and
a first prediction sub-unit, configured to predict the quantity M of sample sub-requests and the texts of the M sample sub-requests through the initial prediction model based on the concatenated content, the quantity M of sample sub-requests being equal to a quantity of single-intent request contents, and the text of each sample sub-request being obtained based on one of the single-intent request contents.

In some embodiments, the sample text of the spoken language request in the multi-intent request scenario includes a multi-intent request content, and the multi-intent request content represents a request content including a plurality of intents.

In some embodiments, the third prediction unit includes:
a second prediction sub-unit, configured to predict the quantity M of sample sub-requests in the sample text of the spoken language request in the multi-intent request scenario and the texts of the M sample sub-requests through the initial prediction model, the quantity M of sample sub-requests being equal to a quantity of intents in the multi-intent request content, and the text of each sample sub-request being obtained based on request content of one intent in the multi-intent request content.

In some embodiments, the sample text in the multi-round request scenario includes a text of a current round and texts of rounds previous to the current round.

In some embodiments, the third prediction unit includes:
a merging sub-units, configured to merge the text of the current round with the texts of the rounds previous to the current round to obtain a merged text, the merged text being configured for representing the text of the current round and the texts of the rounds previous to the current round; and
a third prediction sub-unit, configured to predict the quantity M of sample sub-requests and the texts of the M sample sub-requests through the initial prediction model based on the merged text, the quantity M of sample sub-requests being equal to a quantity 1 of text of the current round, and the texts of the sample sub-requests being obtained by processing the text of the current round in combination with the texts of the rounds previous to the current round.

In some embodiments, the merging sub-unit is specifically configured to extract key information associated with the text of the current round from the texts of the rounds previous to the current round, the key information including at least one of keywords and key sentences; and
merge the key information with the text of the current round to obtain the merged text.

In some embodiments, the third prediction unit further includes:
a generation sub-unit, configured to generate input information based on preset prompt information and the sample text, the preset prompt information including task description information corresponding to the predicted instruction information; and
an input sub-unit, configured to input the input information into the initial prediction model, and predict the quantity M of sample sub-requests and the texts of the M sample sub-requests through the initial prediction model based on the sample text.

In some embodiments, the sample text is a spoken language text, and the generation sub-unit is specifically configured to:
generate the input information based on the spoken language text, the preset prompt information, and preset indication information, the preset indication information being configured for indicating the initial prediction model to output instruction information, and the instruction information including an intent, a domain, and a slot.

In some embodiments, the training unit includes:
a loss determination sub-unit, configured to determine an initial loss value corresponding to each of the plurality of scenarios based on the predicted instruction information;
a fusion sub-unit, configured to fuse the initial loss values to obtain a target loss value; and
a converging sub-unit, configured to converge the initial prediction model based on the target loss value to obtain the prediction model.

In some embodiments, the sample text includes a negative sample text and a positive sample text, the negative sample text includes a sample text in a mislabeled domain, and the positive sample text includes a sample text except the negative sample text in the sample text; and the loss determination sub-unit is specifically configured to:
filter predicted instruction information corresponding to the positive sample text from the predicted instruction information to obtain positive sample instruction information;
filter predicted instruction information corresponding to the negative sample text from the predicted instruction information to obtain negative sample instruction information, and adjust the negative sample instruction information to obtain target negative sample instruction information; and
determine the initial loss value corresponding to each scenario based on the positive sample instruction information and the target negative sample instruction information.

In some embodiments, the dataset obtaining unit 1201 includes:
a template obtaining sub-unit, configured to obtain a first-round dialog template set and at least one sub-round dialog template set, each first-round dialog template in the first-round dialog template set and each sub-round dialog template in the sub-round dialog template set including blank slots;
a combination sub-unit, configured to combine each first-round dialog template in the first-round dialog template set with each sub-round dialog template in the sub-round dialog template set respectively to obtain a plurality of dialog combinations;
an extraction sub-unit, configured to extract entity information from a preset entity library based on the blank slots in the dialog combinations; and
a filling sub-unit, configured to fill the entity information into the dialog combinations to obtain a training dataset in the multi-round request scenario.

In some embodiments, the filling sub-unit is specifically configured to:
fill the entity information into the dialog combinations to obtain multi-round dialog sample texts;
obtain at least one interference text, and interpolate the at least one interference text into the multi-round dialog sample texts to obtain target multi-round dialog sample texts; and
designate the target multi-round dialog sample texts as the training dataset in the multi-round request scenario.

In some embodiments, the third prediction unit is specifically configured to:
match the texts of the M sample sub-requests with the preset entity library respectively to obtain entity information corresponding to each sample sub-request;
update, for each sample sub-request, the sample sub-request based on the entity information corresponding to the sample sub-request to obtain an updated sample sub-request; and
predict the instruction information of the sample text in the corresponding scenario through the initial prediction model based on the updated sample sub-requests, to obtain the predicted instruction information.

During specific implementation, each of the above units may be implemented as an independent entity, or the units may be combined in different manners as the same entity or a plurality of entities for implementation. The specific implementation of each of the above units may be referred to the previous method embodiments, and will not be elaborated here.

An embodiment of this application further provides an electronic device. The electronic device may be a terminal, a server, or the like. The terminal may be a mobile phone, a tablet, a smart Bluetooth device, a laptop, a personal computer, or the like. The server may be a single server, a server cluster composed of a plurality of servers, or the like.

In some embodiments, the text processing apparatus may alternatively be integrated into a plurality of electronic devices. For example, the text processing apparatus may be integrated into a plurality of servers, and the plurality of servers implement the text processing method of this application.

In this embodiment, the electronic device of this embodiment will be described in detail as an example. For example, FIG. 13 shows a schematic diagram of a structure of an electronic device according to an embodiment of this application. Specifically:

The electronic device may include a processor 1301 with one or more processing cores, a memory 1302 with one or more computer-readable storage media, a power supply 1303, an input module 1304, a communication module 1305, and the like. Those skilled in the art can understand that the structure of the electronic device shown in FIG. 13 does not constitute a limitation on the electronic device, and may include more or fewer components than those shown in the figure, or a combination of some components, or components disposed differently. Among the components:

The processor 1301 serves as a control center of the electronic device, connects various parts of the entire electronic device through various interfaces and circuits, and performs various functions of the electronic device and processes data by running or executing software programs and/or modules stored in the memory 1302 and calling data stored in the memory 1302, thereby implementing overall detection on the electronic device. In some embodiments, the processor 1301 may include one or more processing cores. In some embodiments, the processor 1301 may integrate an application processor and a modem processor, where the application processor mainly processes operating systems, user interfaces, application programs, and the like, while the modem processor mainly processes wireless communication. It is understandable that the foregoing modem processor may not be integrated into the processor 1301.

The memory 1302 may be configured to store software programs and modules. The processor 1301 runs the software programs and modules stored in the memory 1302 to perform various functional applications and data processing. The memory 1302 may mainly include a program storage area and a data storage area. The program storage area may store operating systems, applications required by at least one function (such as sound playback function or image playback function), and the like. The data storage area may store data created based on the usage of the electronic device and the like. In addition, the memory 1302 may include a high-speed random access memory, or may include a non-volatile memory, such as at least one magnetic disk storage device, a flash memory device, or other volatile solid-state storage devices. Correspondingly, the memory 1302 may further include a memory controller, to provide access of the processor 1301 to the memory 1302.

The electronic device further includes the power supply 1303 that supplies power to each component. In some embodiments, the power supply 1303 may be logically connected to the processor 1301 through a power management system, thereby enabling functions such as charging, discharging, and power consumption management through the power management system. The power supply 1303 may further include one or more of a direct current or alternating current power supply, a rechargeable system, a power failure detection circuit, a power transformer or inverter, a power state indicator, or the like.

The electronic device may further include an input module 1304. The input module 1304 may be configured to receive inputted digital or character information and generate keyboard, mouse, joystick, optical, or trackball signal inputs related to user settings and function control.

The electronic device may further include the communication module 1305. In some embodiments, the communication module 1305 may include a wireless module. The electronic device may perform short-distance wireless transmission through the wireless module of the communication module 1305, thereby providing users with wireless broadband Internet access. For example, the communication module 1305 may be configured to assist users in transmitting and receiving emails, browsing webs, and accessing streaming media.

Although not shown, the electronic device may further include a display unit and the like, which will not be elaborated here. Specifically, in this embodiment, the processor 1301 in the electronic device loads executable files corresponding to the processes of one or more applications into the memory 1302 according to the following instructions, and the processor 1301 runs the applications stored in the memory 1302, thereby implementing various functions.

The specific implementation of each of the above operations may be found in the previous embodiments and will not be elaborated here.

Those of ordinary skill in the art may understand that all or part of the operations in the various methods of the foregoing embodiments may be completed through instructions or by controlling relevant hardware through instructions, and the instructions may be stored in a non-transitory computer-readable storage medium and loaded and executed by the processor.

To this end, an embodiment of this application provides a non-transitory computer-readable storage medium, having a plurality of instructions stored therein. The instructions can be loaded by a processor to perform the operations in any text processing method provided in the embodiments of this application. For example, the instructions may perform the following operations:

The storage medium may include a read-only memory (ROM), a random access memory (RAM), a magnetic disk, an optical disk, or the like.

According to one aspect of this application, a computer program product or computer program is provided. The computer program product or computer program includes computer instructions stored in a non-transitory computer-readable storage medium. A processor of an electronic device reads the computer instructions from the computer-readable storage medium. The processor executes the computer instructions, enabling the electronic device to perform the method provided in the foregoing embodiments.

Since the instructions stored in the storage medium can be configured for performing the operations in any text processing method provided by the embodiments of this application, the beneficial effects that can be achieved by any text processing method provided by the embodiments of this application can be achieved. Details refer to the previous embodiments and will not be elaborated here.

The technical features of the above embodiments may be combined in different manners. In order to make the description concise, not all possible combinations of the technical features in the above embodiments are described. However, as long as there is no contradiction in the combinations of these technical features, the combinations fall within the scope of the description.

In the embodiments of this application, the term “module” or “unit” refers to a computer program with a preset function or a part of the computer program and works, together with other related parts, to implement a preset target, and may be completely or partially implemented by using software, hardware (such as a processing circuit or a memory) or a combination thereof. Similarly, one processor (or a plurality of processors or memories) may be configured to implement one or more modules or units. In addition, each module or unit may be a part of an overall module or unit including a function of the module or unit. The foregoing embodiments only describe several implementations of this application, and their descriptions are specific and detailed, but cannot therefore be understood as limitations to the patent scope of this application. Those of ordinary skill in the art can make variations and improvements without departing from the concept of this application, and these variations and improvements all fall into the scope of protection of this application. Therefore, the scope of patent protection of this application is subject to the appended claims.

What is claimed is:

1. A text processing method performed by an electronic device, comprising:
obtaining a text of a spoken language request;
predicting a quantity N of sub-requests of the spoken language request and N sub-request texts in one-to-one correspondence with the N sub-requests through an application of a prediction model to the spoken language request text, N being a positive integer; and
predicting target instruction information corresponding to each of the N sub-request texts through the prediction model based on the quantity N of sub-requests and the N sub-request texts for determining a response to the spoken language request.

2. The method according to claim 1, wherein the target instruction information comprises an intent, a domain, and a slot corresponding to the spoken language request.

3. The method according to claim 1, wherein the spoken language request text is one of a text of a spoken language request in a single-intent request scenario, a text of a spoken language request in a multi-intent request scenario, or a text of a round of spoken language request in a multi-round request scenario.

4. The method according to claim 1, wherein the prediction model is trained by:
obtaining a training dataset in a plurality of scenarios, the training dataset comprising at least one sample text corresponding to each scenario;
predicting a quantity M of sample sub-requests and texts of the M sample sub-requests through an initial prediction model based on the sample text, M being a positive integer;
predicting instruction information of the sample text in the corresponding scenario through the initial prediction model based on the quantity M of sample sub-requests and the texts of the M sample sub-requests, to obtain predicted instruction information; and
training the initial prediction model based on the predicted instruction information to obtain the prediction model.

5. The method according to claim 4, wherein the sample text of the spoken language request comprises a single-intent request content, and the single-intent request content represents a request content comprising one intent; and
the quantity M of sample sub-requests is equal to a quantity 1 of intents in the single-intent request content, and the texts of the sample sub-requests are obtained based on the single-intent request content.

6. The method according to claim 4, wherein the sample text of the spoken language request comprises a multi-intent request content, and the multi-intent request content represents a request content comprising a plurality of intents.

7. The method according to claim 4, wherein the predicting a quantity M of sample sub-requests and texts of the M sample sub-requests through an initial prediction model based on the sample text comprises:
generating input information based on preset prompt information and the sample text, the preset prompt information comprising task description information corresponding to the predicted instruction information; and
inputting the input information into the initial prediction model, and predicting the quantity M of sample sub-requests and the texts of the M sample sub-requests through the initial prediction model based on the sample text.

8. The method according to claim 4, wherein the training the initial prediction model based on the predicted instruction information to obtain the prediction model comprises:
determining an initial loss value corresponding to each of the plurality of scenarios based on the predicted instruction information;
fusing the initial loss values to obtain a target loss value; and
converging the initial prediction model based on the target loss value to obtain the prediction model.

9. The method according to claim 4, wherein the obtaining a training dataset in a plurality of scenarios comprises:
obtaining a first-round dialog template set and at least one sub-round dialog template set, each first-round dialog template in the first-round dialog template set and each sub-round dialog template in the sub-round dialog template set comprising blank slots;
combining each first-round dialog template in the first-round dialog template set with each sub-round dialog template in the sub-round dialog template set respectively to obtain a plurality of dialog combinations;
extracting entity information from a preset entity library based on the blank slots in the dialog combinations; and
filling the entity information into the dialog combinations to obtain a training dataset in the plurality of scenarios.

10. The method according to claim 4, wherein the predicting instruction information of the sample text in the corresponding scenario through the initial prediction model based on the quantity M of sample sub-requests and the texts of the M sample sub-requests, to obtain predicted instruction information comprises:
matching the texts of the M sample sub-requests with the preset entity library respectively to obtain entity information corresponding to each sample sub-request;
updating, for each sample sub-request, the sample sub-request based on the entity information corresponding to the sample sub-request to obtain an updated sample sub-request; and
predicting the instruction information of the sample text in the corresponding scenario through the initial prediction model based on the updated sample sub-requests, to obtain the predicted instruction information.

11. An electronic device, comprising a processor and a memory, the memory storing a plurality of instructions; and the processor loading the instructions from the memory to cause the electronic device to perform a text processing method including:
obtaining a text of a spoken language request;
predicting a quantity N of sub-requests of the spoken language request and N sub-request texts in one-to-one correspondence with the N sub-requests through an application of a prediction model to the spoken language request text, N being a positive integer; and
predicting target instruction information corresponding to each of the N sub-request texts through the prediction model based on the quantity N of sub-requests and the N sub-request texts for determining a response to the spoken language request.

12. The electronic device according to claim 11, wherein the target instruction information comprises an intent, a domain, and a slot corresponding to the spoken language request.

13. The electronic device according to claim 11, wherein the spoken language request text is one of a text of a spoken language request in a single-intent request scenario, a text of a spoken language request in a multi-intent request scenario, or a text of a round of spoken language request in a multi-round request scenario.

14. The electronic device according to claim 11, wherein the prediction model is trained by:
obtaining a training dataset in a plurality of scenarios, the training dataset comprising at least one sample text corresponding to each scenario;
predicting a quantity M of sample sub-requests and texts of the M sample sub-requests through an initial prediction model based on the sample text, M being a positive integer;
predicting instruction information of the sample text in the corresponding scenario through the initial prediction model based on the quantity M of sample sub-requests and the texts of the M sample sub-requests, to obtain predicted instruction information; and
training the initial prediction model based on the predicted instruction information to obtain the prediction model.

15. The electronic device according to claim 14, wherein the predicting a quantity M of sample sub-requests and texts of the M sample sub-requests through an initial prediction model based on the sample text comprises:
generating input information based on preset prompt information and the sample text, the preset prompt information comprising task description information corresponding to the predicted instruction information; and
inputting the input information into the initial prediction model, and predicting the quantity M of sample sub-requests and the texts of the M sample sub-requests through the initial prediction model based on the sample text.

16. The electronic device according to claim 14, wherein the training the initial prediction model based on the predicted instruction information to obtain the prediction model comprises:
determining an initial loss value corresponding to each of the plurality of scenarios based on the predicted instruction information;
fusing the initial loss values to obtain a target loss value; and
converging the initial prediction model based on the target loss value to obtain the prediction model.

17. The electronic device according to claim 14, wherein the obtaining a training dataset in a plurality of scenarios comprises:
obtaining a first-round dialog template set and at least one sub-round dialog template set, each first-round dialog template in the first-round dialog template set and each sub-round dialog template in the sub-round dialog template set comprising blank slots;
combining each first-round dialog template in the first-round dialog template set with each sub-round dialog template in the sub-round dialog template set respectively to obtain a plurality of dialog combinations;
extracting entity information from a preset entity library based on the blank slots in the dialog combinations; and
filling the entity information into the dialog combinations to obtain a training dataset in the plurality of scenarios.

18. The electronic device according to claim 14, wherein the predicting instruction information of the sample text in the corresponding scenario through the initial prediction model based on the quantity M of sample sub-requests and the texts of the M sample sub-requests, to obtain predicted instruction information comprises:
matching the texts of the M sample sub-requests with the preset entity library respectively to obtain entity information corresponding to each sample sub-request;
updating, for each sample sub-request, the sample sub-request based on the entity information corresponding to the sample sub-request to obtain an updated sample sub-request; and
predicting the instruction information of the sample text in the corresponding scenario through the initial prediction model based on the updated sample sub-requests, to obtain the predicted instruction information.

19. A non-transitory computer-readable storage medium having a plurality of instructions stored therein, and the instructions, when loaded by a processor of an electronic device, causing the electronic device to perform a text processing method including:
obtaining a text of a spoken language request;
predicting a quantity N of sub-requests of the spoken language request and N sub-request texts in one-to-one correspondence with the N sub-requests through an application of a prediction model to the spoken language request text, N being a positive integer; and
predicting target instruction information corresponding to each of the N sub-request texts through the prediction model based on the quantity N of sub-requests and the N sub-request texts for determining a response to the spoken language request.

20. The non-transitory computer-readable storage medium according to claim 19, wherein the target instruction information comprises an intent, a domain, and a slot corresponding to the spoken language request.
